(19) United States
(12) Patent Application Publication
(10) Pub. No.: US 2006/0200332 A1
(43) Pub. Date: Sep. 7, 2006

(54) CAD system for a printed circuit board

(75) Inventors: Toshio Ishimoto, Echizen-shi (JP); Naofumi Okayama, Echizen-shi (JP); Toshihiko Sasaki, Echizen-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 11/350,788

(22) Filed: Feb. 10, 2006

(30) Foreign Application Priority Data
Feb. 22, 2005 (JP) 2005-046259

(51) Int. Cl. G06F 17/50; G06G 7/62

(52) U.S. Cl. 703/13

(57) ABSTRACT

A pattern design of a film for manufacturing a printed circuit board is made by using a CAD system, and a plurality of types of Gerber data are produced in which a series of various data has been encoded. For example, a pattern film is formed by combining pattern Gerber data with pattern cut Gerber data. Data for check marks whose sizes are different from each other is added as well as pattern data to each Gerber data such that their central coordinates are to be the same. In this manner, a judgment mark having the check marks combined therewith is formed on the pattern film having the items of Gerber data combined therewith.

### BACKGROUND OF THE INVENTION

1. Field of the Invention

The present invention relates to a CAD system for a printed circuit board for producing a plurality of types of Gerber data, hierarchically combining these items of Gerber data, and designing film data for manufacturing a printed circuit board. In particular, the present invention relates to a CAD system for a printed circuit board capable of precisely making judgment whether a film is properly produced within a short period of time.

2. Description of the Related Art

Conventionally, there has been known a manufacturing technique using a film negatively printed to fabricate a printed circuit board on which electric devices or the like, for example, are to be mounted. Now, the most general manufacturing technique will be described below. First, a film in which a wiring pattern has been negatively printed is laminated on a photosensitive substrate of which a copper foil coated with a resist (photosensitive material) is laminated on a substrate surface, and then, exposure is carried out by irradiating light beams. After this exposure process, the film is removed from the photosensitive substrate, and developing is carried out for the exposed photosensitive substrate by a developing liquid. At this time, only a copper foil portion irradiated with light beams remains as a film resist for manufacturing a printed circuit board, and a copper foil portion which has not been irradiated with light beams is fully dissolved by means of the developing liquid. After etching has been completed, after washing, the photosensitive substrate is exposed again, and only the resist remaining on a wiring pattern which appears on the substrate surface is removed by means of the developing liquid again. Then, the substrate is washed and dried, and working is completed.

In recent years, a CAD (Computer Aided Design) system has been often utilized for designing a film to be negatively printed to fabricate such a printed circuit board. In the case where a film for fabricating a printed circuit board is designed by such a CAD system for a printed circuit board, a pattern design is made so as to form an optimal wiring pattern, based on a desired circuit diagram, and Gerber data is outputted such that a series of various data such as shape or size has been encoded.

Currently, there are typically two types of the Gerber data. That is, there are: a standard Gerber data format in which line shape defining data (referred to as an aperture list) and coordinate data are separately provided; and an extended Gerber data format in which these two items of data are associated with each other, and are integrated into one item of data. Then, the above-described Gerber data is captured in a personal computer system in which a CAD system has been installed, and the captured Gerber data is converted to edit data. Then, an editing process is carried out for adding manufacturing information such as a recognition mark required for manufacturing a printed circuit board. Finally, the current data is converted into raster data which printing means such as a plotter can understand, so that a negatively inverted wiring pattern can be printed on a film. Then, in accordance with this raster data, printing data is outputted to a raster plotter, and a negatively inverted pattern is printed onto a set film.

Then, in order to execute a final film printing, a plurality of types of Gerber data such as silk Gerber data, resist Gerber data, pattern Gerber data and the like are hierarchically combined with each other, and printing data is outputted to the plotter. Thus, in the case where a plurality of types of Gerber data are incorrectly combined with each other by an erroneous operation during that process, of course, the film finally produced is different from an expected pattern. Conventionally, however, even if one item of Gerber data is mistakenly combined due to such an incorrect operation, it is impossible to judge whether Gerber data has been combined in accordance with proper procedures or not merely by checking a pattern formed on a film.

In Japanese Patent Application Laid-open No. 7-92652, there is disclosed a production method for, based on graphics data stored in advance, depicting a corresponding graphics or the like on a film and sequentially producing films by printing signs for specifying file data added to that graphics data, and then, reading the graphics, signs or the like depicted and printed on each of the films by a barcode reader and the like, and then, comparing data on the read graphics or the like with graphics data stored to be associated with the file data which corresponds to the read signs so as to make judgment of properness at the time of film production.

According to Japanese Patent Application Laid-open No. 7-92652 described above, based on a plurality of graphics data stored in advance, a corresponding graphics or the like is depicted on a film and a sign for specifying file data added to the graphics data is read, whereby data on the read graphics or the like is compared with graphics data stored to be associated with file data which corresponds to the read sign, and judgment of properness at the time of film production is performed. Therefore, a film finally produced by combining incorrect types of Gerber data by an erroneous operation is compared with graphics data stored in association with that film, thereby making it possible to judge whether the film finally produced is proper or not. However, in Japanese Patent Application Laid-open No. 7-92652, there is a need for specific reading means such as a barcode reader for reading a sign formed on a film because it is necessary to add a sign for specifying file data onto the film, read the sign, and compare the read sign with graphics data. Therefore, equipment configuration is complicated, and it is impossible to simply judge whether or not the film is properly produced merely by a visual check of the film produced by combining a plurality of Gerber data.

### SUMMARY OF THE INVENTION

The present invention has been made to solve the above-described problems. It is an object of the present invention to provide a CAD system for a printed circuit board capable of simply judging whether or not a film is properly produced by a visual check of the film produced by combining a plurality of Gerber data.

According to a first aspect of the present invention, there is provided a CAD system for a printed circuit board, the CAD system producing a plurality of types of Gerber data which correspond to patterns of each film, combining items of the plurality of types of Gerber data thus produced with each other, and producing the films, in the process of designing a plurality of films for use in a resist printing, a wiring pattern forming, and a silk printing of a printed circuit board, wherein image data and check marks which correspond to patterns of each film are included in each Gerber data, the check marks each being a coordinate which corresponds to each Gerber data when combining items of the Gerber data, and a judgment mark for judging properness at the time of film production is formed by combining the checkmarks of each Gerber data.

According to the first aspect of the present invention, a pattern design is made by using the CAD system so as to produce an optimal wiring pattern based on specifications, instructions, or electrical circuit diagrams, and a plurality of types of Gerber data are produced such that a series of various data such as shape or size has been encoded. In order to produce a film for manufacturing a printed circuit board, there are produced: pattern Gerber data, pattern cut Gerber data, resist Gerber data, resist cut Gerber data, silk Gerber data, and forced silk Gerber data. In addition, a pattern film is formed by combining the pattern Gerber data with the pattern cut Gerber data, and a resist film is produced by combining the resist Gerber data with the resist cut Gerber data. In addition, a silk film is produced by combining the silk Gerber data, the forced silk Gerber data, and the resist Gerber data with each other. With respect to these items of Gerber data, check marks are added to their corresponding positions, and their respective check marks are associated with each other so as to form predetermined shapes when items of Gerber data are combined with each other. These check marks are displayed as judgment marks for judging properness at the time of film production.

According to a second aspect of the present invention, in the CAD system for a printed circuit board of the first aspect, there is provided a CAD system for a printed circuit board, wherein a judgment mark formed by combining each Gerber data in accordance with proper procedures is compared with an actual judgment mark displayed by combining a plurality of types of Gerber data during film production so as to make judgment of film properness.

According to the second aspect of the present invention, properness is judged at the time of film production on the basis of the shape of the judgment mark formed by combining items of Gerber data in accordance with proper procedures.

According to a third aspect of the present invention, in the CAD system for a printed circuit board of the second aspect, there is provided a CAD system for a printed circuit board, wherein the judgment mark formed by combining each Gerber data in accordance with proper procedures is formed in a shape common to each of the films.

According to the third aspect of the present invention, the judgment mark formed by combining items of Gerber data in accordance with proper procedures is used in common, making it possible to judge properness at the time of production of a plurality of films on the basis of the shape of one judgment mark.

According to the first aspect of the present invention, there is provided a CAD system for a printed circuit board, the CAD system producing a plurality of types of Gerber data which correspond to patterns of each film, combining items of the plurality of types of Gerber data thus produced with each other, and producing the films, in the process of designing a plurality of films for use in a resist printing, a wiring pattern forming, and a silk printing of a printed circuit board, wherein image data and check marks which correspond to patterns of each film are included in each Gerber data, the check marks each being a coordinate which corresponds to each Gerber data when combining items of the Gerber data, and a judgment mark for judging properness at the time of film production is formed by combining the check marks of each Gerber data. Therefore, it is possible to momentarily judge whether or not a variety of Gerber data are combined with each other in accordance with proper procedures merely by checking a judgment mark. Thus, the properness can be simply judged by visually checking a film produced by combining a plurality of Gerber data.

According to the second aspect of the present invention, in the CAD system for a printed circuit board of the first aspect, there is provided a CAD system for a printed circuit board, wherein a judgment mark formed by combining each Gerber data in accordance with proper procedures is compared with an actual judgment mark displayed by combining a plurality of types of Gerber data during film production so as to make judgment of film properness. Therefore, it is easy to judge whether or not the Gerber data are combined in accordance with the proper procedures by merely checking the judgment mark.

According to the third aspect of the present invention, in the CAD system for a printed circuit board of the second aspect, there is provided a CAD system for a printed circuit board, wherein the judgment mark formed by combining Gerber data in accordance with proper procedures is formed in a shape common to each of the films. Therefore, if the shapes of judgment marks to be formed are different depending on films even when Gerber data is combined properly, it is difficult to judge whether or not there exists a judgment mark formed when Gerber data is combined with each other in accordance with proper procedures at the time of check. However, the judgment mark is used in common in films, thereby enabling judgment by one judgment mark. Thus, reasonable judgment can be made, and efficient checking can be made.

### BRIEF DESCRIPTION OF THE DRAWINGS

FIG. 1 is a block diagram schematically depicting a CAD system according to an embodiment of the present invention;

FIG. 2 is a front view showing pattern Gerber data of the same system;

FIG. 3 is a front view showing pattern cut Gerber data of the same system;

FIG. 4 is a front view showing a pattern film of the same system;

FIG. 5 is a front view showing resist Gerber data of the same system;

FIG. 6 is a front view showing resist cut Gerber data of the same system;

FIG. 7 is a front view showing a resist film of the same system;

FIG. 8 is a front view showing silk Gerber data of the same system;

FIG. 9 is a front view showing forced silk Gerber data of the same system;

FIG. 10 is a front view showing a silk film of the same system;

FIG. 11 is a front view showing a judgment mark of the pattern film of the same system, wherein FIG. 11(a) shows a judgment mark when Gerber data is combined properly, and FIG. 11(b) shows a judgment mark when Gerber data is combined improperly;

FIG. 12 is a front view showing a judgment mark of the resist film of the same system, wherein FIG. 12(a) shows a judgment mark when Gerber data is combined properly, and FIG. 12(b) shows a judgment mark when Gerber data is combined improperly; and

FIG. 13 is a front view showing a judgment mark of the silk film of the same system, wherein FIG. 13(a) shows a judgment mark when Gerber data is combined properly, and FIG. 13(b) shows a judgment mark when Gerber data is combined improperly.

### DESCRIPTION OF THE PREFERRED EMBODIMENT

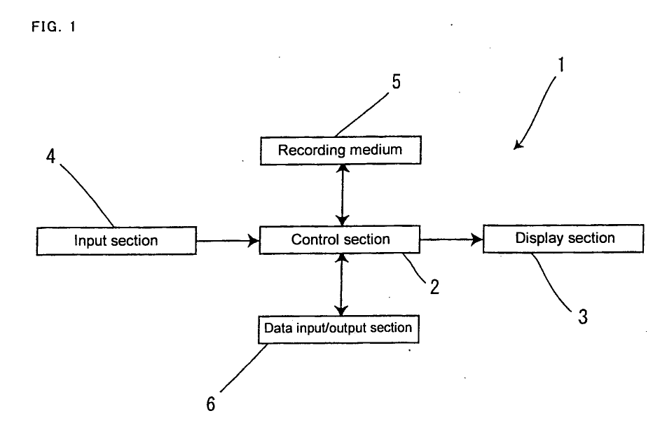

Hereinafter, an embodiment which is the best mode for carrying out the present invention will be described with reference to FIGS. 1 to 13. The following embodiment is provided as a mere aspect for embodying the present invention, and is not provided to limit the present invention within the scope of the embodiment.

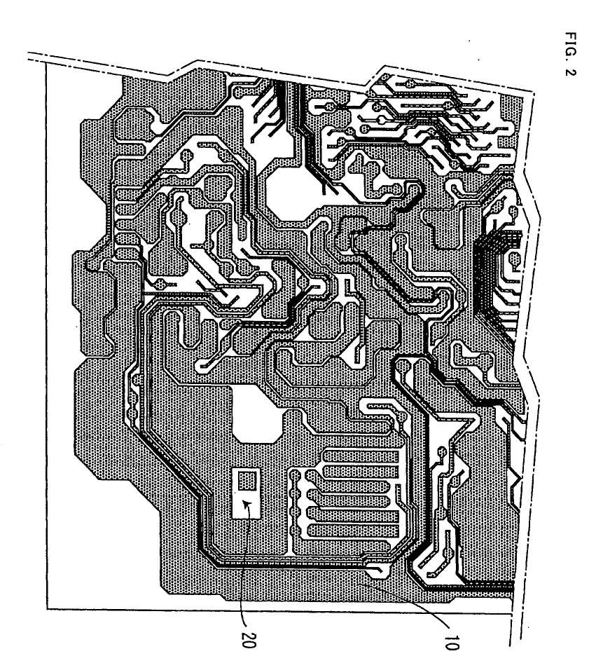

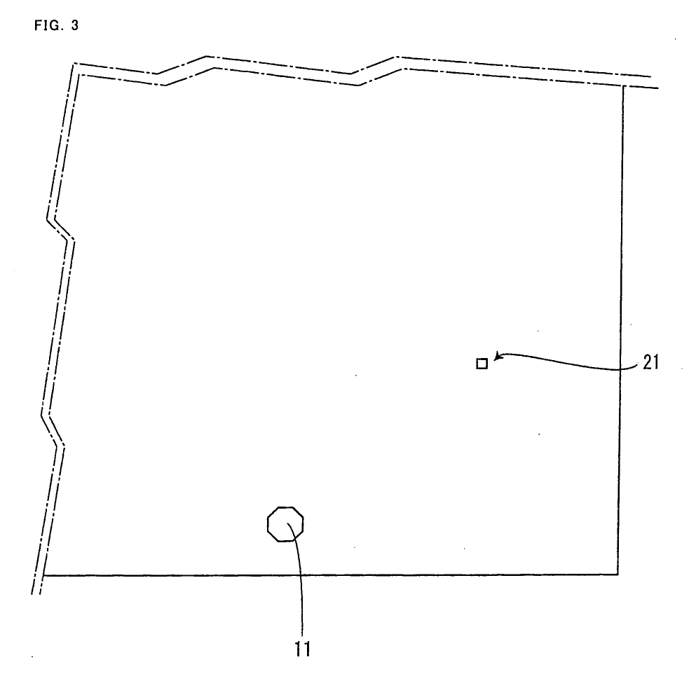

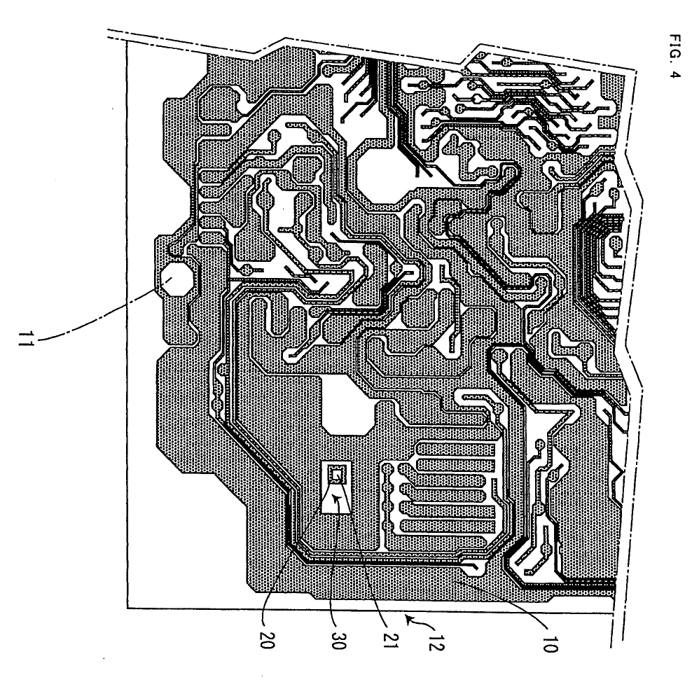

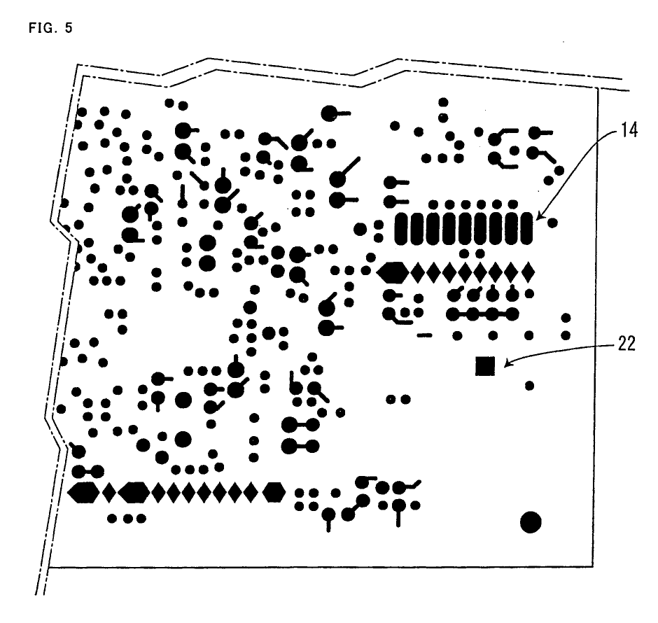

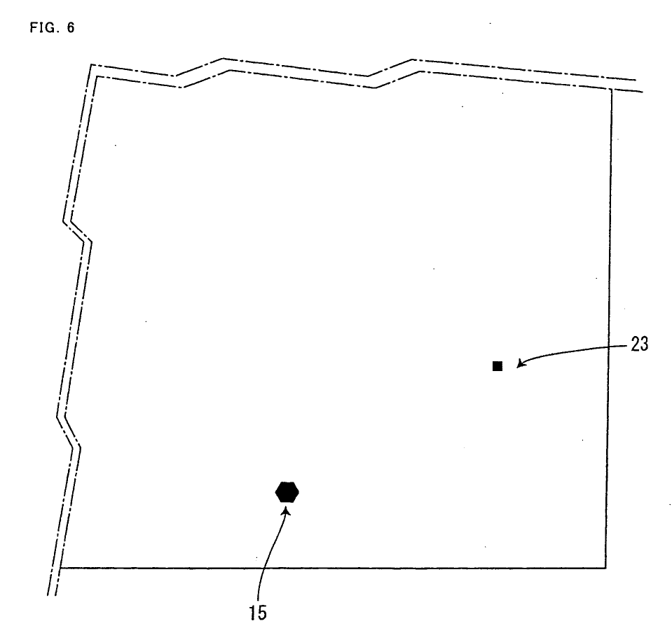

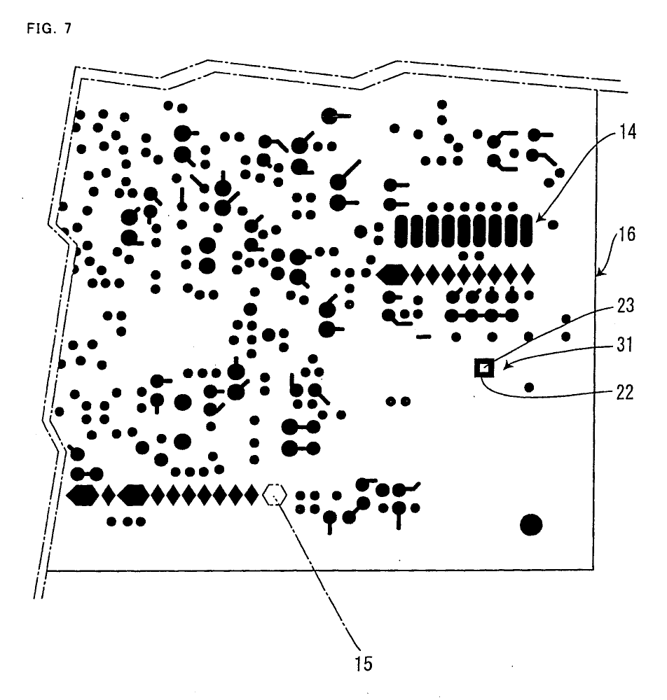

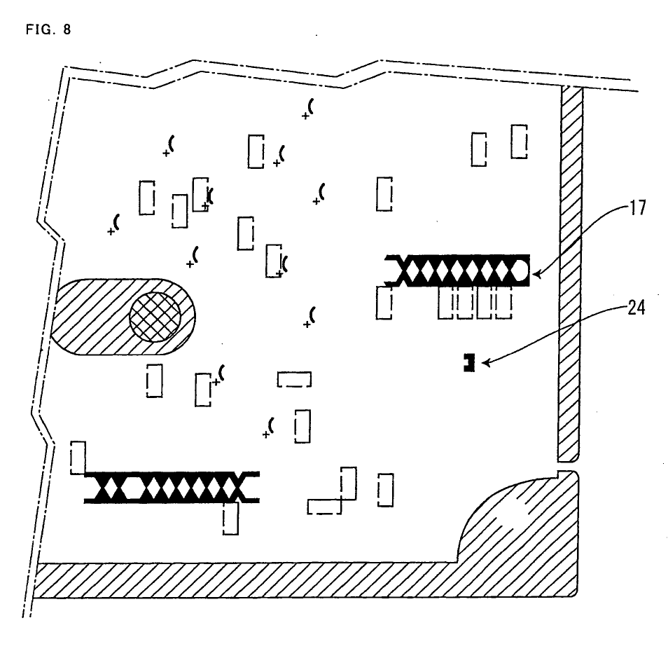

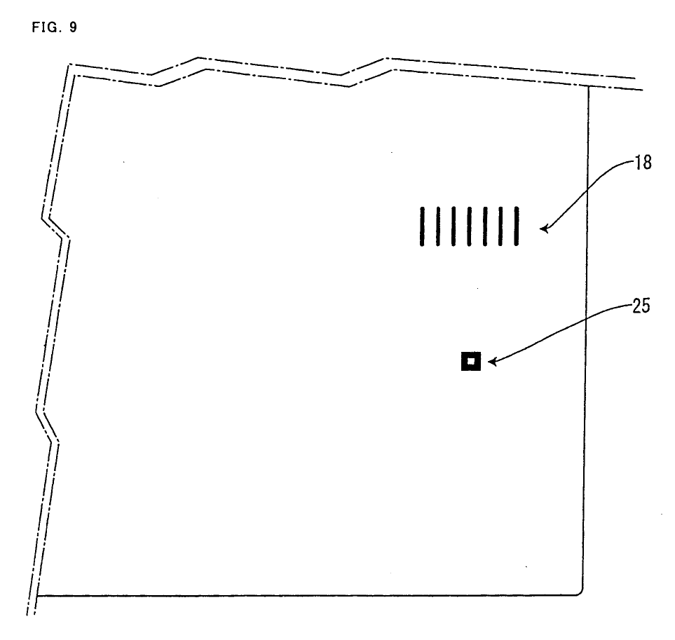

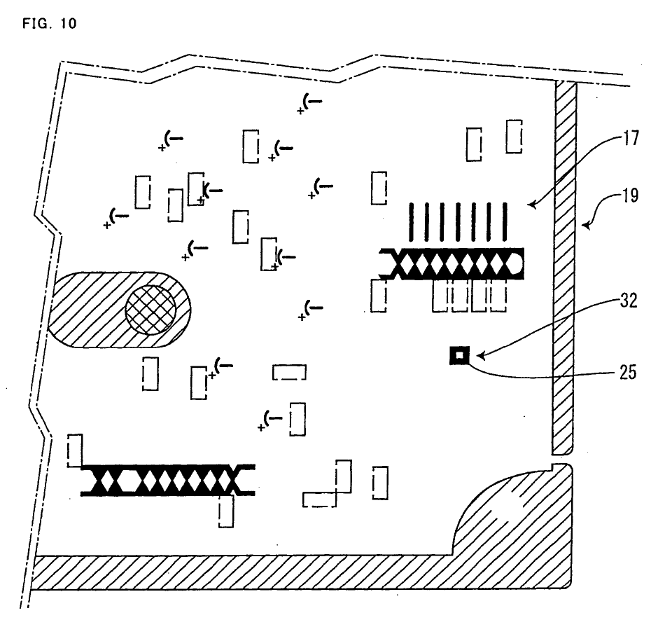

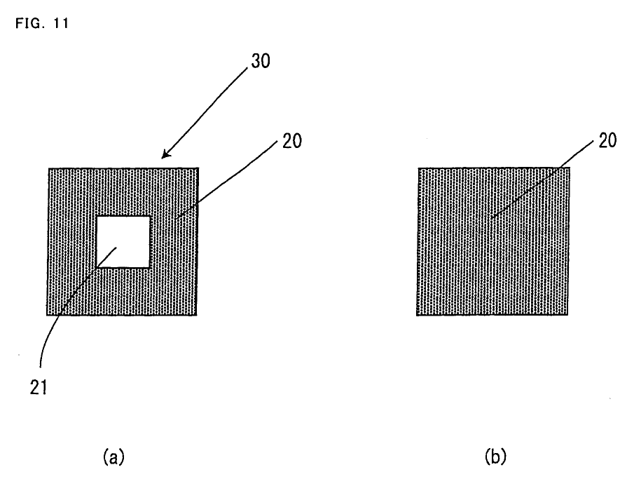

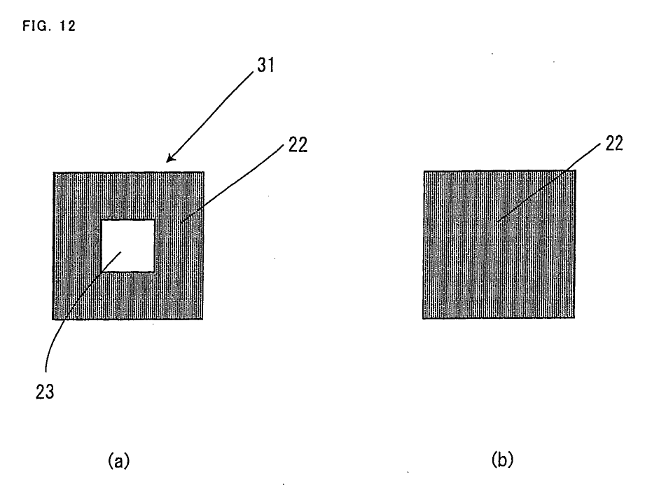

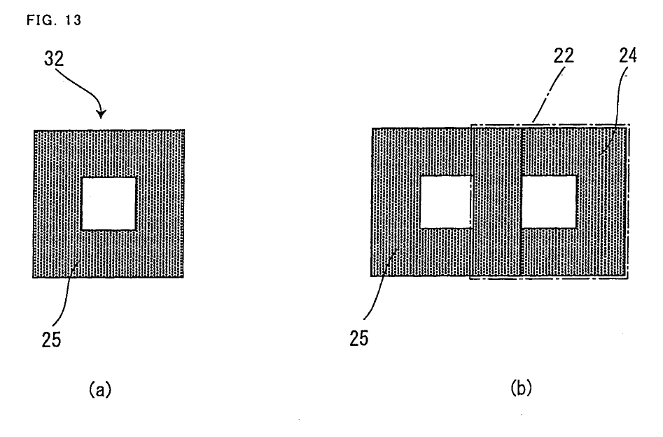

FIG. 1 is a block diagram schematically depicting a CAD system; FIG. 2 is a front view showing pattern Gerber data; FIG. 3 is a front view showing pattern cut Gerber data; FIG. 4 is a front view showing a pattern film; FIG. 5 is a front view showing resist Gerber data; FIG. 6 is a front view showing resist cut Gerber data; FIG. 7 is a front view showing a resist film; FIG. 8 is a front view showing silk Gerber data; FIG. 9 is a front view showing forced silk Gerber data; FIG. 10 is a front view showing a silk film; and FIGS. 11 to 13 show judgment marks of each film, wherein FIG. 11(a) shows a judgment mark of the pattern film when Gerber data is combined properly, FIG. 11(b) shows a judgment mark of the pattern film when Gerber data is combined improperly, FIG. 12(a) shows a judgment mark of the resist film when Gerber data is combined properly, FIG. 12(b) shows a judgment mark of the resist film when Gerber data is combined improperly, FIG. 13(a) shows a judgment mark of the silk film when Gerber data is combined properly, and FIG. 13(b) shows a judgment mark of the silk film when Gerber data is combined improperly.

With reference to a block diagram of FIG. 1, a description will be given with respect to a CAD system 1 for designing a film for manufacturing a printed circuit board in the present embodiment. The CAD system 1 is composed of: a control section 2 composed of a CPU, a ROM, and a RAM or the like and operating under a predetermined program; a display section 3 such as a CRT which displays a variety of images; an input section 4 such as a keyboard, a mouse, a tablet which makes command entry and data input for a variety of works; and an input/output section 6 or the like which inputs and outputs digital data or the like for production of a film for manufacturing a printed circuit board to and from a recording medium 5 such as a hard disk. In addition, based on an electric circuit diagram or instructions, an operator produces a plurality of types of Gerber data. Finally, these items of Gerber data are hierarchically combined with each other, the hierarchically combined data is stored in the recording medium 5 as data required for producing a film for manufacturing a printed circuit board, and the stored data is outputted to printing means such as a plotter.

Now, in the present embodiment configured as above, a series of work procedures for producing a film for manufacturing a printed circuit board will be described with reference to FIGS. 2 to 10.

First, a pattern design is made by using the CAD system 1 so as to form an optimal wiring pattern based on the specifications, instructions, or electric circuit diagrams, and a plurality of types of Gerber data is produced such that a series of various data such as a shape or size has been encoded. That is, in order to produce a film for manufacturing a printed circuit board, there are produced: pattern Gerber data; pattern cut Gerber data; resist Gerber data; resist cut Gerber data; silk Gerber data; and forced silk Gerber data or the like. Then, a pattern film is formed by combining the pattern Gerber data with the pattern cut Gerber data, and a resist film is produced by combining the resist Gerber data and the resist cut Gerber data. Further, a silk film is produced by combining the silk Gerber data with, the forced silk Gerber data, and the resist Gerber data. Then, with respect to the respective items of Gerber data, check marks 20 to 25 are added to their respective corresponding positions.

FIGS. 2 to 10 each show a state in which the various types of Gerber data has been displayed or printed out as an image on the display section 3. A pattern film 12 shown in FIG. 4 is formed by combining pattern Gerber data 10 shown in FIG. 2 with pattern cut Gerber data 11 shown in FIG. 3, and then, deleting image information contained in the pattern cut Gerber data 11 from the pattern Gerber data 10. Square check marks 20 and 21 are added to the pattern Gerber data 10 and the pattern cut Gerber data 11, respectively. These check marks 20 and 21 are formed such that their central coordinates are to be the same, and the check mark 21 of the pattern cut Gerber data 11 is smaller than the check mark 20 of the pattern Gerber data 10. In this manner, in the pattern film 12 formed by combining the pattern Gerber data 10 and the pattern cut Gerber data 11, if Gerber data is combined properly, a judgment mark 30 is formed in such a manner that the check mark 21 of the pattern cut Gerber data 11 has been removed from the center part of the check mark 20, as shown in FIG. 11(a). In the meantime, if Gerber data is combined improperly, only the check mark 20 is formed as shown in FIG. 11(b).

A resist film 16 shown in FIG. 7 is formed by combining resist Gerber data 14 shown in FIG. 5 with resist cut Gerber data 15 shown in FIG. 6, and then, deleting image information contained in the resist cut Gerber data 15 from the resist Gerber data 14. As in the pattern film 12, square check marks 22 and 23 are added, respectively, such that their central coordinates are to be the same, and the check mark 23 of the resist cut Gerber data 15 is smaller than the check mark 22 of the resist Gerber data 14. In this manner, in the resist film 16 formed by combining the resist Gerber data 14 and the resist cut Gerber data 15, if Gerber data is combined properly, a judgment mark 31 is formed in such a manner that the check mark 23 of the resist cut Gerber data 15 has been removed from the center part of the check mark 22, as shown in FIG. 12(a). In the meantime, if Gerber data is combined improperly, only the check mark 22 is formed as shown in FIG. 12(b).

A silk film 19 shown in FIG. 10 is formed by combining silk Gerber data 17 shown in FIG. 8, forced silk Gerber data 18 shown in FIG. 9, and the resist Gerber data 14 shown in FIG. 5 with each other, deleting image information contained in the resist Gerber data 14 from the silk Gerber data 17, and overlapping the image information contained in the forced silk Gerber data 18 on the image data. With respect to the silk Gerber data 17, a U-shaped check mark 24 is formed at the same coordinate position as the check mark 22 of the resist Gerber data 14. With respect to the forced silk Gerber data 18, a square shaped check mark 25 whose center is opened is formed at the coordinate position adjacent in a transverse direction to the check mark 24. In this manner, in the silk film 19 formed by combining the silk Gerber data 17, the forced silk Gerber data 18, and the resist Gerber data 14, if Gerber data is combined properly, a judgment mark 32 on which only the check mark 25 of the forced silk Gerber data 18 remains is formed as shown in FIG. 13(a). In the meantime, for example, in the case where the resist Gerber data 14 is left uncombined, the check mark 25 is continuous aside the check mark 24, as shown in FIG. 13(b).

As described above, in the present embodiment, after the check marks 20 to 25 have been added to a variety of Gerber data 10, 11, 14, 15, 17, and 18, respectively, when the pattern film 12, the resist film 16, and the silk film 19 are formed, the check marks 20 to 25 are combined with each other, and the judgment marks 30, 31, and 32 are formed. This makes it possible to very simply judge whether or not the variety of Gerber data 10, 11, 14, 15, 17, and 18 have been combined with each other in accordance with proper procedures merely by checking the judgment marks 30, 31, and 32. Further, in the foregoing embodiment, when Gerber data is combined properly, the shape of the judgment marks 30, 31, and 32 formed in the pattern film 12, the resist film 16, and the silk film 19 is uniform, thus making it possible to momentarily judge an error if any shape other than the uniform shape of the judgment marks 30, 31, and 32 is detected. Therefore, very efficient judgment can be made. In this manner, it is possible to judge whether the pattern film 12, the resist film 16, and the silk film 19, which are used for manufacturing a printed circuit board, are formed properly or not by means of the judgment marks 30, 31, and 32. This makes it possible to efficiently manufacture each of the films 12, 16, and 19 and to facilitate and speed up production.

While one embodiment of the present invention has been described in detail, the present invention is not limited to the embodiment described previously, and various modifications can occur without departing from the spirit of the present invention. For example, while the embodiment has shown an example in which the check marks 20 to 25 are formed inside of a printed circuit board, these marks may be formed outside of the printed circuit board. In this case, there is no restriction on a layout of the printed circuit board depending on the check marks 20 to 25, and thus, flexible design can be made. In addition, the shapes of the check marks 20 to 25 are not limited to the foregoing embodiment. For example, when Gerber data is combined properly, after combining the check marks 20 to 25 with each other, characters or graphic signs such as “Proper” or “OK” may be displayed, thereby making it possible to judge properness more easily. In addition, in the present embodiment, while a silk film 19 is produced by combining silk Gerber data 17, forced silk Gerber data 18, and resist Gerber data 14 with each other, the present invention can be applied similarly even in the case of producing a silk film 19 by using silk cut Gerber data instead of the resist Gerber data 14.

What is claimed is:

1. A CAD system for a printed circuit board, the CAD system producing a plurality of types of Gerber data which correspond to patterns of each film, combining items of the plurality of types of Gerber data thus produced with each other, and producing the films, in the process of designing a plurality of films for use in a resist printing, a wiring pattern forming, and a silk printing of a printed circuit board, wherein
image data and check marks which correspond to patterns of each film are included in each Gerber data, the check marks each being a coordinate which corresponds to each Gerber data when combining items of the Gerber data, and
a judgment mark for judging properness at the time of film production is formed by combining the check marks of each Gerber data.

2. The CAD system for a printed circuit board according to claim 1, wherein a judgment mark formed by combining each Gerber data in accordance with proper procedures is compared with an actual judgment mark displayed by combining a plurality of types of Gerber data during film production so as to make judgment of film properness.

3. The CAD system for a printed circuit board according to claim 2, wherein the judgment mark formed by combining each Gerber data in accordance with proper procedures is formed in a shape common to each of the films.
